(19) United States
(12) Patent Application Publication
(10) Pub. No.: US 2019/0337253 A1
(43) Pub. Date: Nov. 7, 2019

(54) BALE PRESS

(71) Applicant: CK International Limited, Dungannon, County Tyrone (GB)

(72) Inventors: Paul Conlon, Dungannon, County Tyrone (GB); Gareth McCullagh, Dungannon, County Tyrone (GB)

(21) Appl. No.: 16/481,292

(22) PCT Filed: Jan. 25, 2018
(86) PCT No.: PCT/EP2018/051891

§ 371 Date: Jul. 26, 2019

(30) Foreign Application Priority Data
Jan. 27, 2017 (GB) 1701379.8

(51) Int. Cl. B30B 9/30

(52) U.S. Cl. CPC B30B 9/3078; B30B 9/3014; B30B 9/301; B30B 9/3007

(57) ABSTRACT

A bale press includes a substantially horizontal main press chamber, the main press chamber incorporating a main press in the form a moveable wall moveably mounted within the main press chamber between retracted and advanced positions in a direction parallel to a longitudinal axis of the main press chamber. A side chamber is positioned along one side of the main press chamber and has a side press mounted for movement within the side chamber between retracted and advanced positions in a direction generally perpendicular to the longitudinal axis of the main press chamber so that material within the side chamber may be compressed into the main press chamber by movement of the side press between the retracted and advanced positions. A feed hopper for material to be baled is positioned above the side chamber for delivering material into the side chamber when the side press is retracted.

### CROSS REFERENCE TO RELATED APPLICATIONS

The present application is a § 371 national stage of International Application PCT/EP2018/051891, filed Jan. 25, 2018, which claims priority benefit to U.K. Pat. Application Ser. No. 1701379.8, filed Jan. 27, 2017, both of which are hereby incorporated herein by reference in their entireties.

### FIELD OF THE INVENTION

This invention relates to a bale press for compressing waste material into bales.

### BACKGROUND OF THE INVENTION

Bale presses are used to compress waste or recyclable material, such as cardboard, rags, light metals and the like, and to strap or wrap the compressed and compacted waste into bales. Powerful rams are used to compact and compress such waste material into as small a bale or bundle as practicable.

Typically waste material is introduced through a feed hopper into a press chamber, subsequent to which a pre-press lid is forcefully closed down over the press chamber to pre-compress the material therein. A main press, in the form of a movable wall of the press chamber, is then advanced to compress the material in the press chamber into one end of the chamber. In one type of baling press the press chamber has a closed end opposite the moveable wall, wherein material is compressed against the closed end, an ejector opening being provided in a side of the press chamber adjacent the closed end, the ejection opening be closable by a door during compression of material into the press chamber, the door being openable when a bale is to be ejected from press chamber. An ejector device, such as a moveable wall, is typically provided opposite the ejection opening for pushing the bale out of the press chamber through the ejection opening. A tying device may be associated with the press chamber or may be provided adjacent the ejection opening for tying straps or other wrapping devices around the bale.

In operation, waste material is delivered to the feed hopper and passes under gravity into the press chamber. The pre-press lid is closed and the main press is advanced to compress the material into the closed end of the press chamber. The main press is then retracted and pre-press lid may be opened to allow more material to be passed into the press chamber, before closing the pre-press lid and once again advancing the main press to further compress the material into the closed end of the press chamber.

This process may be repeated several times depending upon the compressibility of the material until a compact bale is formed in the closed end of the press chamber. Then, with the main press still in its advanced position, the ejection door is opened and the ejector device operated to eject a bale from the ejection opening. This is a relatively slow process, particularly for highly compressible materials. Thus downstream processes for delivering material to the baling press must be interrupted or otherwise slowed to a slower than optimum speed to allow time for the operation of the baling press.

### SUMMARY OF THE INVENTION

According to one form of the present invention there is provided a bale press with a substantially horizontal main press chamber, the main press chamber having a longitudinal axis and incorporating a main press in the form a moveable wall mounted for movement within the main press chamber between a retracted and an advanced position in a direction parallel to the longitudinal axis of the main press chamber. A side chamber is positioned along one side of the main press chamber and includes a side press in the form of a moveable wall mounted for movement within the side chamber between a retracted and an advanced position, and in a direction generally perpendicular to the longitudinal axis of the main press chamber so that material within the side chamber may be compressed into the main press chamber by movement of the side press between the retracted and advanced positions. A feed hopper for material to be baled is positioned above the side chamber for delivering material into the side chamber when the side press is in its retracted position.

In one aspect, the main press chamber is closed from above so that material from the feed hopper can only enter the main press chamber via the side chamber.

Optionally, a pre-press lid is associated with the feed hopper, movable between an open position, to permit material to pass from the feed hopper into the side chamber, and a closed position, wherein the pre-press lid compresses the material into the side chamber.

In one embodiment the pre-press lid is in the form of a quarter section of a cylinder having a rectangular shaped plane face and an adjacent curved face, the pre-press lid being mounted for rotation between the open position, wherein the plane face extends substantially upwardly to allow material to be fed from the feed hopper into the side chamber, and the closed position, wherein the plane face extends substantially horizontally to define an upper wall of the side chamber.

The main press may be driven by an actuator, such as one or more double acting rams, between its retracted and advanced positions to compress and compact material into one end of the main press chamber to form a bale therein. A similar actuator or actuator may be provided for moving the side press between its retracted and advanced positions.

Optionally, the main press is arranged to move past an opening between the side chamber and the main press chamber during movement between its retracted and advanced positions, thereby closing communication between the side chamber and the main press chamber.

In one embodiment the volume of the side chamber may be greater than the volume of an adjacent region of the main press chamber such that material in the side chamber is compacted as it is moved into the main press chamber by the side press.

An actuator, such as one or more double acting rams, may be provided for moving the pre-press lid between its open and closed positions.

In one embodiment an ejector door may be provided for selectively closing an ejection opening in a side of the main press chamber adjacent a closed distal end of the main press chamber against which end material is compressed by the main press. An ejector device, in the form of a movable wall, may be provided in a side wall of the main press chamber opposite the ejection opening, the ejector device being is moveable from a retracted position, where the moveable wall of the ejector device is contiguous with the adjacent side wall of the main press chamber, and an extended position, wherein the moveable wall of the ejector device extends into the main press chamber to press the compressed material within the main press chamber out of the ejection opening as a compacted bale. A bale tying device may be provided adjacent the ejection opening for wrapping straps or webs around the formed bale and tying or otherwise joining such straps or webs around the ejected bale to hold the bale together.

In an alternative embodiment the main press chamber may have an open ended tunnel or channel through which the material is extruded into bales.

According to another form of the present invention there is provided a method of operating a bale press generally in accordance with the first form of the invention described above, the method including the steps of :
a. Feeding material into the side chamber via the feed hopper with the side press in its retracted position;
b. With the main press in its retracted position, advancing the side press to its advanced position to push and compress material from the side chamber into the main press chamber;
c. With the side press in its advanced position, advancing the main press to its advanced position to form a bale in the main press chamber; and
d. Once the main press moves past an opening between the side chamber and the main press chamber during movement between its retracted and advanced positions, thereby closing communication between the side chamber and the main press chamber, retracting the side press and refilling the side chamber via the feed hopper.

Where the bale press further includes a pre-press lid between the feed hopper and the side chamber, the method may further include the steps of :
i. Opening the pre-press lid until the side chamber is full and then;
ii. Closing the pre-press lid to close the side chamber and pre-compress material therein;
iii. Opening the pre-press lid once the side press moves past an opening between the feed hopper and the side chamber such that material can build up in the feed hopper above the side chamber before passing into the side chamber once the side press returns to its retracted position; and
iv. Repeating steps (h) and (iii).

These and other objects, advantages and features of the invention will become apparent upon review of the following specification in conjunction with the drawings.

### BRIEF DESCRIPTION OF THE DRAWINGS

A bale press in accordance with an embodiment of the present invention will now be described, by way of example only, with reference to the accompanying drawings, in which

FIG. 1 is a perspective view of a bale press in accordance with an embodiment of the present invention;

FIG. 2 is a plan view of the apparatus of FIG. 1;

FIG. 3 is an end view in direction A of FIG. 1;

FIG. 4 is an end view in direction B of FIG. 1;

FIG. 5 is a schematic plan view of the apparatus of FIG. 1; and

FIG. 6 is a flow chart illustrating the operation of the apparatus of FIG. 1.

### DETAILED DESCRIPTION OF THE DRAWINGS

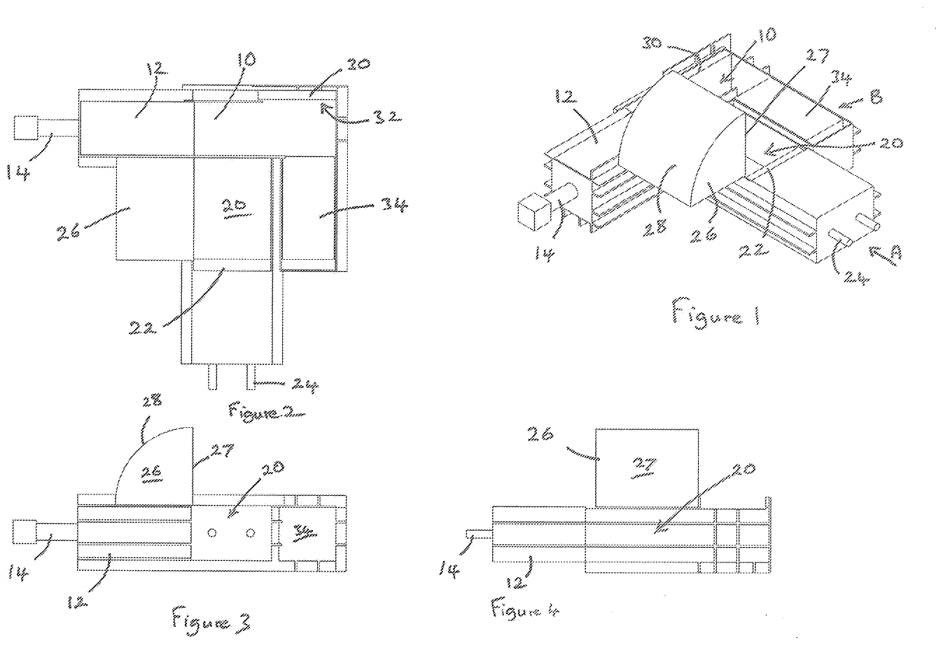

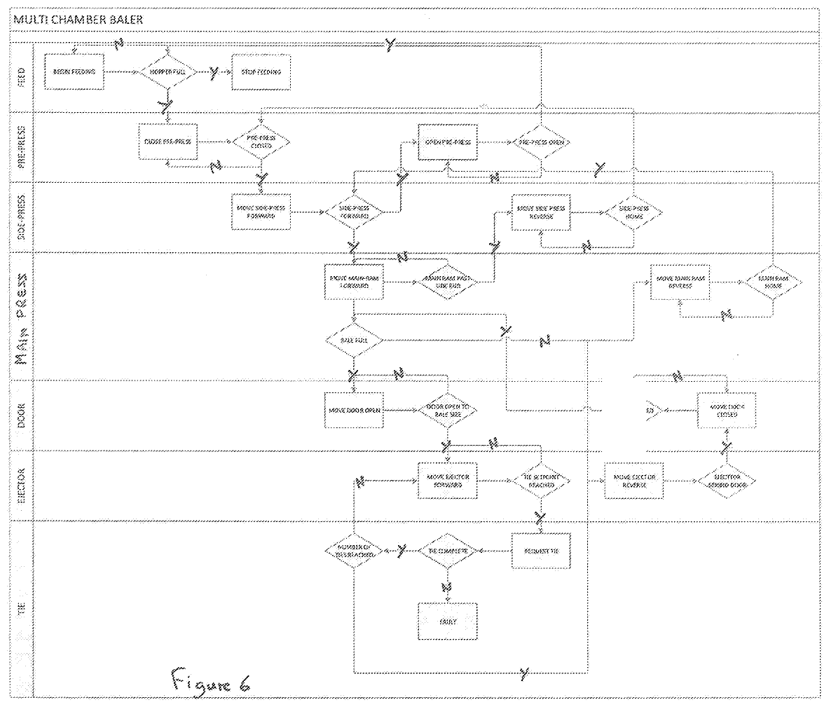

Referring now to the drawings an the illustrative embodiments depicted therein, a bale press in accordance with an embodiment of the present invention is illustrated schematically in FIGS. 1 to 5. The bale press has a substantially horizontal main press chamber 10 with a substantially rectangular cross section, the main press chamber 10 incorporating a main press 12 in the form a moveable end wall driven by a suitable actuator 14, such as one or more double acting hydraulic rams, the main press 12 being mounted for movement within the main press chamber 10 between a retracted and an advanced position in a direction parallel to the longitudinal axis thereof, such that the main press 12 can compress and compact material into one end of the main press chamber 10 to form a bale therein.

A side chamber 20 is positioned along one side of the main press chamber 10. A side press 22, in the form of a moveable end wall of the side chamber 20 driven by a suitable actuator 24 such as one or more double acting hydraulic rams, is mounted for movement within the side chamber 20 between a retracted and an advanced position and in a direction generally perpendicular to the longitudinal axis of the main press chamber 10 so that material within the side chamber 20 may be compressed into the press chamber 10 by movement of the side press 22 between its retracted and advanced positions. The volume of the side chamber 20 is preferably greater than the volume of the adjacent region of the main press chamber 10 such that material in the side chamber 20 is compacted as it is moved into the main press chamber 10.

The side chamber 20 opens into the main press chamber 10 when the main press 12 is in its retracted position. Communication between the side chamber 20 and the main press chamber 10 is closed by the main press 12 when the main press approaches its advanced position.

A feed hopper (not shown) for material to be baled is positioned above the side chamber 20 for delivering material into the side chamber 20 when the side press 22 is in its retracted position. A conveyor (not shown) may be provided for feeding material to the feed hopper.

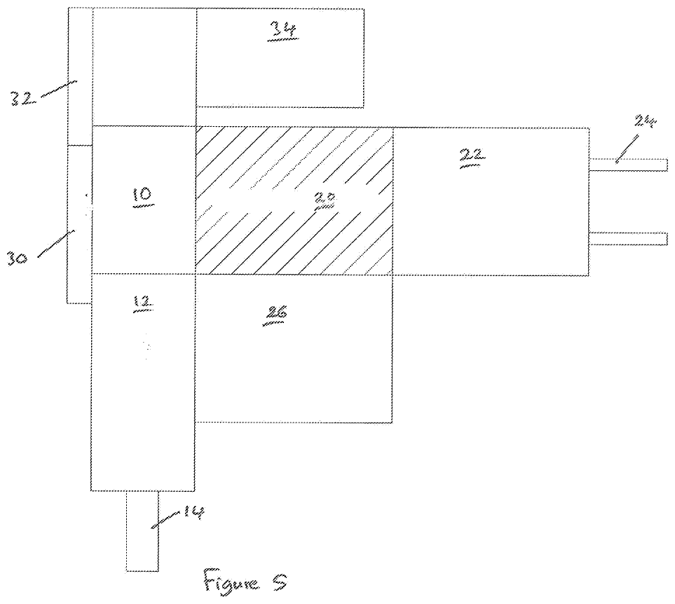

A pre-press lid 26 is associated with the feed hopper, being mounted above the side chamber 20 for closing the side chamber 20 when it has been filled from the feed hopper. As best shown in FIGS. 1 and 3, the pre-press lid 26 is in the form of a quarter section of a cylinder having a rectangular shaped plane face 27 and an adjacent curved face 28. The pre-press lid 26 is mounted for rotation between an open position (shown in FIGS. 1 to 5), wherein the plane face 27 extends substantially upwardly to allow material to be fed from the feed hopper into the side chamber 20, and a closed position, wherein the plane face 27 extends substantially horizontally to define an upper wall of the side chamber 20, closing the side chamber 20. An actuator, such as one or more double acting hydraulic rams, is provided for moving the pre-press lid 26 between its open and closed positions.

An ejector door 30 is provided for selectively closing an ejection opening 32 in the side of the main press chamber 10 adjacent a closed distal end 16 of the main press chamber 10 against which material is compressed by the main press 12. An ejector device 34, in the form of a movable wall driven by a suitable actuator, such as one or more double acting hydraulic rams, is provided in a side wall of the main press chamber 10 opposite the ejection opening 32. The ejector device 34 is moveable from a retracted position, where the moveable wall of the ejector device 34 is contiguous with the adjacent side wall of the main press chamber 10, and an extended position, wherein the moveable wall of the ejector device 34 extends into the main press chamber 10 to press the compressed material within the main press chamber 10 out of the ejection opening 32 as a compacted bale.

A bale tying device (not shown) is provided adjacent the ejection opening 32 for wrapping straps or webs around the formed bale and tying or otherwise joining such straps or webs around the ejected bale to hold the bale together as is known in the art and thus will not be described in more detail.

The operation of the bale press is illustrated in FIG. 6.

With the pre-press lid 26 in its open position, the side press 22 in its retracted position and the main press 12 in its retracted position, material is fed into the side chamber 20 via the feed hopper. When the side chamber 20 is full, the pre-press lid 26 is closed, pre-compressing the material in the side chamber 20.

Next the side press 22 is advanced, pushing the material into the main press chamber 10 and compressing it at the same time due to the greater volume of the side chamber 20 compared to the adjacent region of the main press chamber 10. Once the side press 22 reaches its advanced position, with its moveable wall substantially contiguous with the adjacent side wall of the main press chamber 10, the main press is advanced, with the ejector door closed 30, compressing material into the closed end of the main press chamber 10.

When the side press 22 reaches its advanced position, the pre-press lid may be opened such that material can pass into the feed hopper and build up in the feed hopper above the side chamber 20 (on top of the advanced side press 22).

As soon as the main press 12 moves past the opening between the side chamber 20 and the main press chamber 10, closing communication between the side chamber 20 and the main press chamber 10, the side press 22 is returned to its retracted position, allowing material from the feed hopper to refill the side chamber 20, and the pre-press lid 26 is once again closed to pre-compress the material into the side chamber 20, ready to be subsequently moved into the main press chamber 10 once the main press 12 has been retracted.

Once the main press 12 reaches its advanced position it is determined whether or not the closed end of the main press chamber 10 is full, if not, the main press is retracted and the side press 22 is advanced to push more material from the side chamber 20 into the main press chamber 10 in front of the main press 12.

The main press 12 is once again advanced and the side press 22 is retracted once the main press 12 closes off communication between the side chamber 20 and the main press chamber 10.

This sequence repeats until the closed end of the main press chamber 10 is full (for example determined by the back pressure against the main press 12). Once it is determined that the main press chamber 10 is full, with the main press 12 remaining in its advanced position, the ejector door 30 is opened and the ejection device 34 is advanced to push the bale out of the ejection opening 32 and the tying device is operated to wrap straps or ties around the bale and tie or otherwise join the straps or ties, preventing the compacted material from re-expanding. Once the bale has been ejected the ejection device 34 is retracted and the ejector door 30 is closed, closing the ejection opening 32.

The main press 12 is moved to its retracted position and the cycle of refilling the main press chamber 10 via the side chamber 20 proceeds.

By feeding material into a side chamber 20 having a separate side press 22 from the feed hopper and the increased volume of the side chamber 20 compared to the adjacent region of the main press chamber 10 permits the volume of material supplied into the press during each press cycle to be greatly increased compared to the prior art. Furthermore, the ability to open the press lid 26 as soon as the side press 22 has reached its advanced position and the ability to retract the side press 22 to refill the side chamber 20 as soon as the main press 12 moves past the side chamber 20 minimises any disruption in the supply of material to the feed hopper. It may be possible to control the speed of the feed of material into the side hopper (from a suitable conveyor) to allow as substantially constant flow of material into the feed hopper.

The invention is not limited to the embodiment described herein but can be amended or modified without departing from the scope of the present invention, which is intended to be limited only by the scope of the appended claims as interpreted according to the principles of patent law including the doctrine of equivalents.

1. A bale press comprising:
a substantially horizontal main press chamber, said main press chamber having a longitudinal axis and incorporating a main press in the form a moveable wall mounted for movement within said main press chamber between a retracted and an advanced position in a direction parallel to the longitudinal axis of said main press chamberand;
a side chamber positioned along one side of said main press chamber and having a side press in the form of a moveable wall mounted for movement within said side chamber between a retracted and an advanced position and in a direction generally perpendicular to the longitudinal axis of the main press chamber so that material within said side chamber is compressible into said main press chamber by movement of said side press between the retracted and advanced positions; and
a feed hopper for material to be baled, said feed hopper positioned above said side chamber for delivering material into said side chamber when said side press is the retracted position.

2. The bale press of claim 1, wherein said main press chamber is closed from above so that material from said feed hopper can only enter said main press chamber via said side chamber.

3. The bale press of claim 2, wherein a pre-press lid is associated with said feed hopper, movable between an open position, to permit material to pass from said feed hopper into said side chamber, and a closed position, wherein said pre-press lid is adapted to compress said material into said side chamber.

4. The bale press of claim 3, wherein said pre-press lid is in the form of a quarter section of a cylinder having a rectangular shaped plane face and an adjacent curved face, said pre-press lid being mounted for rotation between said open position, wherein said plane face extends substantially upwardly to allow material to be fed from said feed hopper into said side chamber, and said closed position, wherein said plane face extends substantially horizontally to define an upper wall of said side chamber.

5. The bale press of claim 1, wherein said main press is driven by an actuator between its retracted and advanced positions to compress and compact material into one end of said main press chamber to form a bale therein.

6. The bale press of claim 1, wherein said main press is arranged to move past an opening between said side chamber and said main press chamber during movement between its retracted and advanced positions, thereby closing communication between said side chamber and said main press chamber.

7. The bale press of claim 1, wherein the volume of the side chamber is greater than the volume of an adjacent region of said main press chamber such that material in said side chamber is compacted as it is moved into said main press chamber by said side press.

8. The bale press of claim 1, wherein an ejector door is provided for selectively closing an ejection opening in a side of said main press chamber adjacent a closed distal end of said main press chamber against which end material is compressed by said main press.

9. The bale press of claim 8, wherein an ejector device, in the form of a movable wall, is provided in a side wall of said main press chamber opposite said ejection opening, said ejector device being is moveable from a retracted position, where said moveable wall of said ejector device is contiguous with said adjacent side wall of said main press chamber, and an extended position, wherein said moveable wall of said ejector device extends into or through said main press chamber to press the compressed material within said main press chamber out of said ejection opening as a compacted bale.

10. The bale press of claim 9, wherein a bale tying device is provided adjacent said ejection opening for wrapping straps or webs around the formed bale and tying or otherwise joining such straps or webs around the ejected bale to hold the bale together.

11. A method of operating a bale press comprising a substantially horizontal main press chamber, the main press chamber having a longitudinal axis and incorporating a main press in the form a moveable wall mounted for movement within the main press chamber between a retracted and an advanced position in a direction parallel to the longitudinal axis of the main press chamber, and a side chamber positioned along one side of the main press chamber and having a side press in the form of a moveable wall mounted for movement within the side chamber between a retracted and an advanced position and in a direction generally perpendicular to the longitudinal axis of the main press chamber so that material within the side chamber may be compressed into the main press chamber by movement of the side press between the retracted and advanced positions, and a feed hopper for material to be baled being positioned above the side chamber for delivering material into the side chamber when the side press is in its retracted position, the method comprising the steps of :
a. Feeding material into the side chamber via the feed hopper with the side press in its retracted position;
b. With the main press in its retracted position, advancing the side press to its advanced position to push and compress material from the side chamber into the main press chamber;
c. With the side press in its advanced position, advancing the main press to its advanced position to form a bale in the main press chamber; and
d. Once the main press moves past an opening between the side chamber and the main press chamber during movement between its retracted and advanced positions, thereby closing communication between the side chamber and the main press chamber, retracting the side press and refilling the side chamber via the feed hopper.

12. The method of operating a bale press as claimed in claim 11, wherein the bale press further comprises a pre-press lid and wherein the main press is arranged to move past an opening between the side chamber and the main press chamber during movement between its retracted and advanced positions, thereby closing communication between the side chamber and the main press chamber, the method further comprising the steps of :
i. Opening the pre-press lid until the side chamber is full and then;
ii. Closing the pre-press lid to close the side chamber and pre-compress material therein;
iii. Opening the pre-press lid once the side press moves past an opening between the feed hopper and the side chamber such that material can build up in the feed hopper above the side chamber before passing into the side chamber once the side press returns to its retracted position; and
iv. Repeating steps (ii) and (iii).
